(19) United States
(12) Patent Application Publication
(10) Pub. No.: US 2023/0122975 A1
(43) Pub. Date: Apr. 20, 2023

(54) INTEGRATED MULTIPART HOUSING FOR AN ELECTRONIC DEVICE

(71) Applicant: Apple Inc., Cupertino, CA (US)

(72) Inventors: Jagbir S. Dhillon, Cupertino, CA (US); Christopher D. Prest, San Francisco, CA (US); Tyler S. Atura Bushnell, Mountain View, CA (US); William A. Counts, Sunnyvale, CA (US)

(21) Appl. No.: 17/502,721

(22) Filed: Oct. 15, 2021

(51) Int. Cl. G04G 17/08; H01Q 1/27; G04G 21/08; G04G 21/04; G06F 1/16

(52) U.S. Cl. CPC G04G 17/08; H01Q 1/273; G04G 21/08; G04G 21/04; G06F 1/163; G06F 3/041

(57) ABSTRACT

Embodiments are directed to a portable wearable device having a housing that includes a shell formed from a sheet metal material and defining an outer surface of the portable wearable device and a frame formed from a polymer material molded to an inner surface of the shell. The housing also includes a cover glass coupled to a ledge of the frame, where the frame and the cover glass define at least a portion of a sealed cavity. The portable wearable device may include a display assembly coupled to an inner surface of the cover glass such that the display assembly is positioned within the sealed cavity.

### FIELD

The described embodiments relate generally to housings for electronic devices. More particularly, the present embodiments relate to sheet metal housings for mobile electronic devices such as smartwatches and smartphones.

### BACKGROUND

Electronic devices such as smartwatches and smartphones include antennas for receiving and transmitting data using various wireless communication protocols. Various antenna components can be positioned at different locations on an electronic device. In some cases, antenna components can be integrated into structures of an electronic device such as a housing. However, the operation of the antenna can be affected when placed in close proximity to other conductive structures on an electronic device such as metallic housing components. As the density of electronic components in devices increases, the close proximity of the various electronics can negatively affect antenna function. It may be desirable to have additional ways to tune and/or improve antenna function in electronic devices.

Additionally, it can be desirable to protect electronic components contained within a device from water, dust, debris, or other contaminants. Many electronic devices are manufactured using sealing processes that increase manufacturing complexity and cost and introduce added design constraints based on the incorporated seals. It may be desirable to have sealed electronic devices that reduce manufacturing and/or design complexities.

### SUMMARY

Embodiments are directed to a portable wearable device that includes a housing having a shell formed from a sheet metal material and defining an outer surface of the portable wearable device and a frame formed from a polymer material molded to an inner surface of the shell, where the frame defines an opening and a ledge extending around the opening. The housing can also include a cover glass coupled to the ledge of the frame, where the frame and the cover glass define at least a portion of a sealed cavity. The portable wearable device can include a display assembly coupled to an inner surface of the cover glass and positioned within the sealed cavity.

Embodiments are also directed to an electronic watch that includes a housing having a shell formed from a first sheet metal material, a first molded component formed from a first polymer material molded to an inner surface of the shell, and a second molded component formed from a second polymer material molded to the first molded component. The second molded component can be configured to deflect in response to a press input. The housing can also include a cover coupled to the first molded component, where the first molded component and the cover at least partially define a sealed cavity. The electronic watch can also include a touch-sensitive display coupled to the cover and configured to detect a touch input on the cover. The electronic watch can include an input device positioned inward of the second molded component and configured to detect the press input.

Embodiments are further directed to a wearable electronic device that includes a housing having a first sheet metal component defining a first portion of an exterior surface of the wearable electronic device, a second sheet metal component defining a second portion of the exterior surface, and a frame component molded to the first sheet metal component and the second sheet metal component, and defining a third portion of the exterior surface. The housing can also include a cover coupled to the frame component. The wearable electronic device can include a display positioned inward of the cover and an antenna positioned inward of the cover and electrically coupled to the first sheet metal component.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a perspective view of an example electronic device having a multipart housing structure;

FIG. 1B shows an exploded view of the electronic device shown in FIG. 1A;

FIG. 2 shows a cross-sectional view of a portion of the electronic device shown in FIG. 1A

FIG. 3 shows a perspective view of an example multipart housing structure for an electronic device;

FIG. 4A shows a cross-sectional view of a portion of the electronic device shown in FIG. 3;

FIG. 4B shows a cross-sectional view of a portion of the electronic device shown in FIG. 3;

FIG. 5A shows a top perspective view of an example multipart housing structure for an electronic device;

FIG. 5B shows a bottom perspective exploded view of a multipart housing structure for an electronic device;

FIG. 6 shows a perspective view of an example multipart housing structure for an electronic device;

FIG. 7 shows a perspective view of an example multipart housing structure for an electronic device;

FIG. 8 shows a perspective view of an example multipart housing structure for an electronic device;

FIG. 9 is an example process flow for creating a multipart housing structure; and

FIG. 10 is an example block diagram of an electronic device having a multipart housing structure.

It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims. The embodiments disclosed herein are directed to multipart electronic device housings that provide the appearance and durability associated with an all-metal housing while providing more easily manufactured parts that may be easier to seal. The embodiments described herein may also allow various novel features such as antenna splits and may also reduce manufacturing costs and complexity.

Embodiments disclosed herein are directed to an electronic device having a multi-part housing structure that includes a shell formed from a sheet metal material and a frame formed from a polymer material. The shell can be formed using stamping or other sheet forming processes and the frame can be molded to an inner surface of the shell. The electronic device can include a display assembly that is coupled to the frame to define a portion of a sealed cavity that contains electronic components. The frame can separate electronic components such as an antenna from the shell. For example, the electronic device includes an antenna that is coupled to the display assembly and the frame can help electrically isolate the antenna from the frame. In other cases, the frame can separate and/or electrically isolate different sections or portions of the shell. For example, the frame can be molded between a lower shell portion and an upper shell portion. In this regard, the separate shell portions can function as different feed and ground points for an antenna.

The electronic device can include input components such as a touch-sensitive display, buttons, a crown in the cases of a smartwatch, and so on. In some cases, the input components or portions thereof can be coupled to the frame to seal the inside of the electronic device from water, debris, or other contaminants. For example, the frame can be formed from a molded material and an input button can be molded to the frame. In these cases, the shell can include openings for input components such as a button. However, the sealing of the electronic device can occur between the frame and the input component. In some cases, the input components can be coupled to the frame using adhesives or other sub-assembly processes. In other cases, the input components or portion of the input component can be molded directly to the frame. For example, the frame can be formed from a first polymer material as part of a first molding process and an input component can be formed from a second polymer material as part of a second molding process that forms the input component directly on the frame. Directly forming input components on the frame may increase robustness and/or reliability of the seals and/or reduce manufacturing costs.

The shell can be formed from a sheet metal forming processes such as stamping, bending, or other suitable processes. In some cases, the shell can include multiple discrete components that are separated and held in place by the frame. In some cases, the shell can be formed from a combination of processes such as stamping and welding, brazing, or other metal joining techniques which may allow for more complex structures. Forming the shell using sheet metal materials and processes can reduce manufacturing complexity and cost, such as by reducing waste compared to machining a solid block of material.

The frame can be formed directly on the shell, for example using molding techniques such as insert-molding, or other suitable processes. Molding the frame can also allow for more complex design as compared to machining operations, such as allowing the frame to have larger and/or angled undercuts, thinner wall segments, and so on. In this regard, forming the multi-part housing component can have an outer shell which may increase durability, appearance, robustness of the electronic device, and reduce manufacturing costs due to sheet metal processes. In addition, the frame can be coupled to input components such as a display assembly, buttons, and a crown to seal the electronic device while also allowing for more complex structures as compared to all metal or primally metal machined housings.

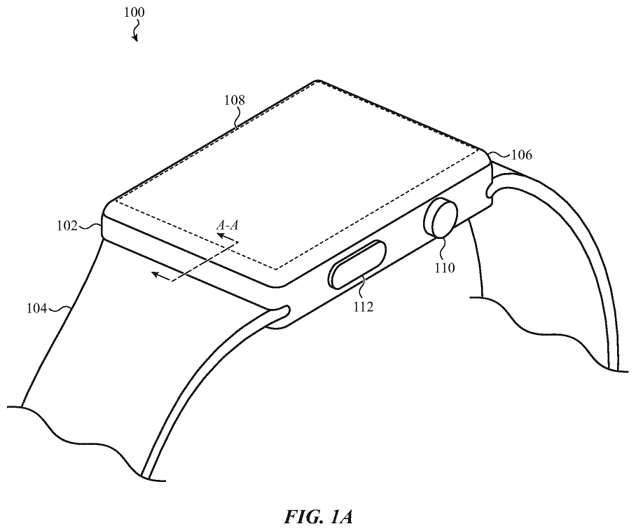

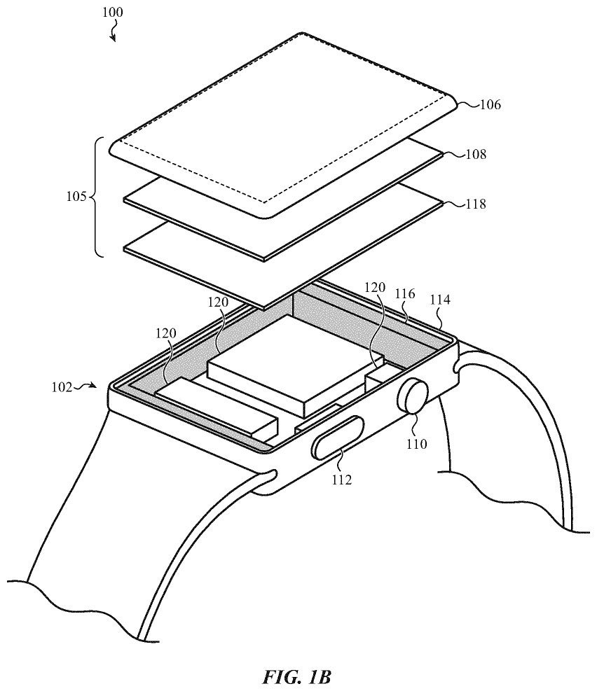

These and other embodiments are discussed below with reference to FIGS. 1A-10. However, those skilled in the art will readily appreciate that the detailed description given herein with respect to these figures is for explanatory purposes only and should not be construed as limiting.

FIG. 1A shows a perspective view of an example electronic device 100 having a multipart housing structure. The electronic device 100 is depicted as an electronic watch (e.g., a smartwatch), though this is one example embodiment of an electronic device and the concepts discussed herein may apply equally or by analogy to other electronic devices, including mobile phones (e.g., smartphones), tablet computers, notebook computers, head-mounted displays, digital media players (e.g., mp3 players), health-monitoring devices, or the like.

The electronic device 100 may include a housing 102 and a band 104 coupled to the housing 102. The band may be configured to couple the electronic device 100 to a user, such as to the user's arm or wrist. A portion of the band 104 may be received in a band slot that is defined by a channel formed along a side of the housing 102, as described herein. The band 104 may be secured to the housing 102 within the channel to maintain the band 104 to the housing 102.

The electronic device 100 also includes a transparent cover 106 (which may be referred to simply as a “cover”) coupled with the housing 102 and positioned over a display 108. The cover 106 and the housing 102 along with other components may form a sealed internal volume of the electronic device 100, which may contain the internal electrical components of the electronic device 100. In some cases, the cover 106 defines substantially the entire front face and/or front surface of the electronic device 100. The cover 106 may also define an input surface of the electronic device 100. For example, as described herein, the electronic device 100 may include touch and/or force sensors that detect inputs applied to the cover 106. The cover 106 may be formed from or include glass, sapphire, a polymer, a dielectric, or any other suitable material.

The display 108 may be positioned under the cover 106 and at least partially within the housing 102. The display 108 (which may be referred to simply as a “display”) may define an output region in which graphical outputs are displayed. Graphical outputs may include graphical user interfaces, user interface elements (e.g., buttons, sliders, etc.), text, lists, photographs, videos, or the like. The display 108 may include a liquid-crystal display (LCD), an organic light emitting diode display (OLED), or any other suitable components or display technology. In some cases, the display 108 may output a graphical user interface with one or more graphical objects that display information.

The display 108 may be touch- and/or force-sensitive and include or be associated with touch sensors and/or force sensors that extend along the output region of the display and which may use any suitable sensing elements and/or sensing techniques. Using touch sensors, the electronic device 100 may detect touch inputs applied to the cover 106, including detecting locations of touch inputs, motions of touch inputs (e.g., the speed, direction, or other parameters of a gesture applied to the cover 106), or the like. Using force sensors, the electronic device 100 may detect amounts or magnitudes of force associated with touch events applied to the cover 106. The touch and/or force sensors may detect various types of user inputs to control or modify the operation of the device, including taps, swipes, multiple finger inputs, single- or multiple-finger touch gestures, presses, and the like. Touch and/or force sensors usable with wearable electronic devices, such as the electronic device 100, are described below.

The electronic device 100 may also include a crown 110 having a cap, protruding portion, or component(s) or feature(s) (collectively referred to herein as a “body”) positioned along a side surface of the housing 102. At least a portion of the crown 110 (such as the body) may protrude from, or otherwise be located outside, the housing 102, and may define a generally circular shape or circular exterior surface. The exterior surface of the body of the crown 110 may be textured, knurled, grooved, or otherwise have features that may improve the tactile feel of the crown 110 and/or facilitate rotation sensing.

The crown 110 may facilitate a variety of potential interactions. For example, the crown 110 may be rotated by a user (e.g., the crown may receive rotational inputs). Rotational inputs of the crown 110 may zoom, scroll, rotate, or otherwise manipulate a user interface or other object displayed on the display 108 (among other possible functions). The crown 110 may also be translated or pressed (e.g., axially) by the user. Translational or axial inputs may select highlighted objects or icons, cause a user interface to return to a previous menu or display, or activate or deactivate functions (among other possible functions). In some cases, the electronic device 100 may sense touch inputs or gestures applied to the crown 110, such as a finger sliding along the body of the crown 110 (which may occur when the crown 110 is configured to not rotate) or a finger touching the body of the crown 110. In such cases, sliding gestures may cause operations similar to the rotational inputs, and touches on an end face may cause operations similar to the translational inputs. As used herein, rotational inputs include both rotational movements of the crown (e.g., where the crown is free to rotate), as well as sliding inputs that are produced when a user slides a finger or object along the surface of a crown in a manner that resembles a rotation (e.g., where the crown is fixed and/or does not freely rotate). In some embodiments, rotating, translating, or otherwise moving the crown 110 initiates a pressure measurement by a pressure-sensing system (such as an external and/or internal pressure-sensing device) located on or within the electronic device 100. In some cases, selecting an activity, requesting a location, specific movements of the user, and so on may also initiate pressure measurements by the pressure-sensing system.

The electronic device 100 may also include other inputs, switches, buttons, or the like. For example, the electronic device 100 includes a button 112. The button 112 may be a movable button (as depicted) or a touch-sensitive region of the housing 102. The button 112 may control various aspects of the electronic device 100. For example, the button 112 may be used to select icons, items, or other objects displayed on the display 108, to activate or deactivate functions (e.g., to silence an alarm or alert), or the like.

FIG. 1B shows an exploded view of the electronic device 100 shown in FIG. 1A. The housing 102 can include multiple components including a shell 114 and a frame 116. The shell 114 and the frame 116 can be coupled to form a unified housing 102 structure. In some cases, the shell 114 can be formed from a sheet material such as sheet metal and be formed from one or more sheet forming processes such as stamping. The frame 116 can be formed on the shell 114 using molding processes such as insert molding or other suitable techniques. The shell 114 can be formed from metal materials such as steel, stainless steel, aluminum, titanium or other suitable metals or alloys, or combinations thereof. In this regard, the metal material of the shell 114 may increase the robustness of the electronic device 100 or provide for a desired appearance. The frame 116 can include polymer materials such as injection molded polymer materials, such as polyimide (nylons), polyethylene materials, polycarbonate materials, styrene materials, polypropylene materials, polyimide materials, acrylonitrile Butadiene Styrene (ABS) materials, rubbers such as silicone rubbers, combinations thereof, or any other suitable polymer materials. In some cases, the frame can include composite polymer materials such as glass filled polymers carbon, graphite or metal reinforced polymers, or any other suitable composite materials. Composite materials can include fiber materials, bead materials, and/or any other suitable reinforcing particles. In some cases, the shell 114 and the frame 116 can be configured to have similar thermal expansion properties such as matched coefficients of thermal expansion.

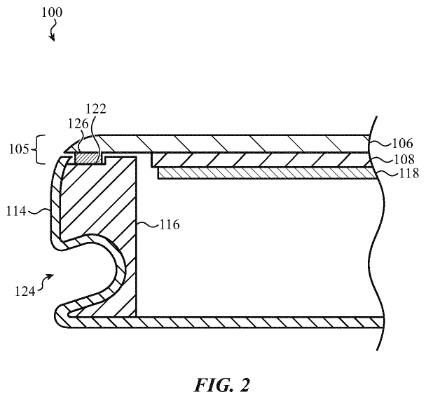

The electronic device can include a display assembly 105 that is coupled to the housing 102 to define a portion of a sealed cavity that contains electronic components 120. In some cases, the display assembly 105 is coupled to the frame 116 to form the portion of the sealed cavity. For example, the display assembly 105 can be hermitically sealed to the frame 116 to prevent moisture, dust, debris, or other contaminants from entering the sealed cavity. The display assembly 105 can be sealed to the cavity using various techniques that include using adhesive such as pressure sensitive adhesives, seals, gaskets, or any other suitable techniques or combinations thereof. In some cases, the frame 116 can include features such as a shelf (shown in FIG. 2), grooves or notches that help align the frame 116 and the display assembly 105 and/or contain seals, adhesives, and so on.

In some cases, the display assembly 105 can include the cover 106 and the display 108 as described herein. The display assembly 105 can also include an antenna component 118, which can be used for wireless communications. For example, the antenna component 118 can be coupled to a bottom side of the display assembly 105 such that it is contained within the cavity and sealed from the outside environment. In some cases, the antenna can be integrated with display components of the display assembly 105. For example, the antenna may be a layer of conductive material within the display stack. The conductive layer can form an electrode layer of the stack that operates a portion of the time in a display mode and a portion of the time in an antenna mode. The antenna mode may be between the display refresh operations such that the display appears to be continuously operating while the electrode layer also conducts wireless communications as an antenna.

In some cases, the frame 116 can electrically isolate input components such as the crown 110 and/or button 112. For example, in health sensing application the crown 110 can be configured to function as a lead for an electrocardiogram (EGG) and the frame 116 can electrically isolate the crown from other portions of the housing 102 such as the shell. Additionally or alternatively, the frame 116 can also separate other portions of the shell such as described herein. In this regard, different portions of the housing 102 and/or input components such as the crown 110 can function as independent ECG leads.

FIG. 2 shows a cross-sectional view of a portion of the electronic device 100 shown in FIG. 1A. The antenna component 118 can include one or more antenna structures such as receive and/or transmit structures, integrated chips that process antenna signals, and other components such as feeds and grounding structures. In some cases, the performance of an antenna can be improved if one or more portions of the antenna such as receive and transmit structures are isolated or positioned away from other conductive portions of the electronic device such as the shell 114. The display assembly 105 can be configured to increase a distance between the shell 114 and the antenna components 118, for example, as compared to devices with a singular metal housing structure. For example, the frame 116 is formed from an insulating material such as a polymer. In this regard, having the frame 116 can help antenna performance by positioning the antenna components 118 further from the shell 114.

The frame 116 can define a ledge 122 and the cover 106 can be coupled to the ledge 122 to create a sealed internal cavity. The ledge 122 can extend around an opening defined by the frame 116. In some cases, the cover 106 is coupled to the frame 116 by a coupling layer 126. The coupling layer 126 can include adhesives, seals, or other suitable techniques as described herein. In some cases, a bottom/back side of the cover 106 can include features that promote coupling of the cover to the frame 116 such as grooves, surface texture, or other suitable structures that help seal and/or align the cover with the housing 102. In some cases, the coupling layer 126 can include touch and/or force sensors such as a capacitive based sensor that is configured to detect a press or other force exerted on the cover 106.

In some cases, the shell 114 can define a back wall and side walls that extend from the back wall. The back wall and the side walls can have a substantially uniform thickness.

In some cases, the shell 114 can include features that are used to attach a band, or other feature to the housing 102. The band can be configured in a variety of ways and include a single strap, multiple straps, links, or any other suitable structure for attaching the electronic device to a user. The shell 114 can define a band attachment feature 124 such as a slot, groove, hole, or other suitable feature. The shell 114 can be a sheet metal part and the band attachment feature 124 can be formed by bending a metal sheet into a defined shape such as an elongated groove. This can include stamping, bending, or other sheet metal forming processes. In some cases, multiple sheet metal parts can be connected together and the assembly can form one or more features of the housing 102 such as the band attachment feature 124. This can include brazing, welding, or otherwise coupling the multiple sheet metal parts together. The frame 116 can be molded to the shell 114 and can surround features in the shell, which may help reinforce the shell 114. For example, when the shell 114 is formed from a sheet metal part, it may have a substantially uniform thickness, but be relatively thinner than the frame 116. Accordingly, the frame 116 can be molded onto the sheet metal features of the shell 114.

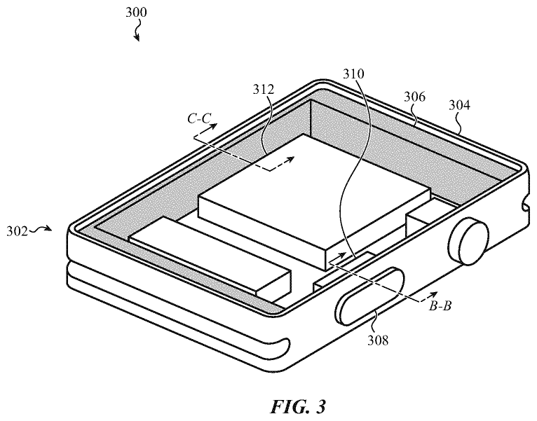

FIG. 3 shows a perspective view of an electronic device 300 that has a multipart housing 302, which can be an example of the electronic devices described herein. The multi-part housing 302 can include a shell 304 coupled to a frame 306 as described herein. The electronic device 300 can include input components 310 such as a crown and/or buttons, and include electronic components 312 within an internal cavity, as described herein. The electronic components can include a battery, a haptic device, a logic board, a system on a chip, wireless communication hardware, or any other suitable electronic circuitry.

In some cases, the housing 302 can include integrated buttons, or other interfaces that are used to interact with input components such as a button or crown as described herein. For example, the housing 302 can include a molded button member 308 that forms an outer portion of the housing 302 to seal a button assembly 310 inside the housing 302.

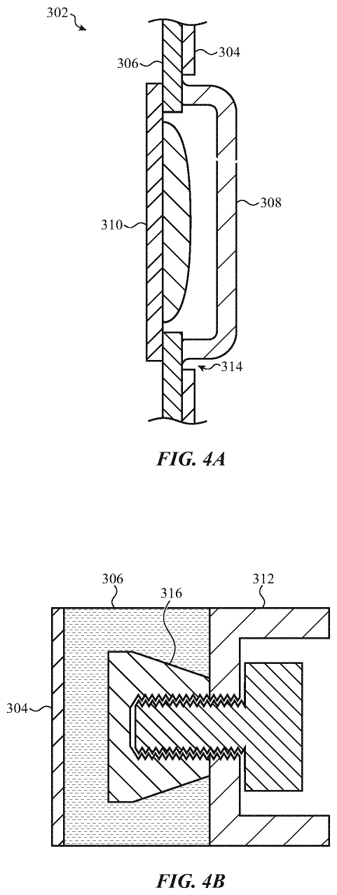

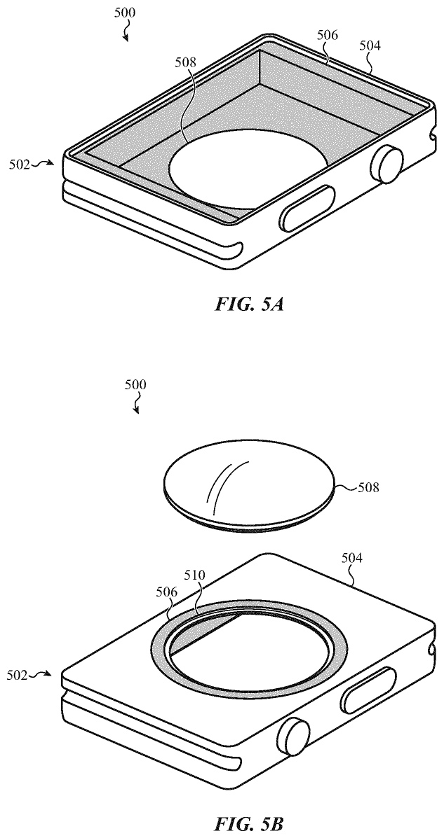

FIG. 4A shows a cross-sectional view of the molded button member 308 along section line B-B shown in FIG. 3. The housing can include the shell 304 which can be a formed sheet metal part as described herein, and the frame 306 which can be molded to the shell 304. The button member 308 can be a molded component that is molded to the frame 306 as part of one or more manufacturing processes. In some cases, these manufacturing processes can create a seal between the button member 308 and the frame 306, which can prevent the ingress of water, dust, debris or other contaminants into the interior of the housing 302. In some cases, the button assembly 310 can be an electronic part such as an electromagnetic switch, force sensing switch, capacitive sensor, dome switch, or any other suitable type of switch, or combination thereof. The button assembly 310 can be positioned inward of the button member 308 such that it is sealed within the interior of the housing 302. The button member 308 can be formed from a molding process such as an over molding type process and/or an insert molding type process that molds the button member 308 to the frame 306.

In some cases, the button member 308 can deform in response to a press input by a user. The button member 308 can be formed from the same material as the frame 306 or a different material from the frame 306. For example, the frame 306 can be formed from a first polymer material such as nylon and/or reinforced nylon and the button member 308 can be formed from a second polymer material such as a silicone or other similar polymer. In some cases, the button member 308 can be formed from a more compliant material than the frame 306 so that the button member 308 deforms in response to a press input while the frame 306 remains relatively undeformed. The shell 304 can define an opening 314 and the button member 308 can be positioned in the opening 314. In this regard, the button member 308 and the frame 306 are coupled to form a sealed interior cavity. The button member 308 is provided as an example of an integrated input and/or output structure that can be incorporated into the housing 302 and these concepts can be applied to other input output structures such as a crown, speaker ports, and so on.

Additionally or alternatively, the frame 306 can include other input/output components such as a speaker membrane. For example, a speaker membrane such as a liquid silicone rubber can be molded to the frame 306. In this regard, the speaker membrane may form an outer structure of a speaker assembly and additional speaker components can be mounted to the frame and positioned inside the sealed housing.

In some cases, the frame 306 can include features that are used to couple components of an electronic device to the housing 302. For example, the frame 306 can include molded, machined, bonded, and/or other features that are used to connect components such as the electronic components 312. For example, the frame 306 can include a polymer post that an electronic component 312 is positioned over and the polymer post is deformed to secure the electronic component in place. In other cases, the frame 306 can include threaded inserts, press-fit, snap fit, or any other suitable engagement features. The electronic components 312 can include batteries, integrated circuits, processing components, haptic engines, speaker components, input/output components, or other components contained within or otherwise attached to the housing.

FIG. 4B shows a cross-sectional view of the housing 302 and the electronic component 312 along line C-C shown in FIG. 3. The frame 306 can include an attachment feature 316 that is used to couple the electronic component 312 to the housing 302. In some cases, the attachment feature 316 can be formed as part of one or more molding processes that are used to form the frame 306. In this regard, the frame 306 can define attachment features that may not be able to be created through machining operations. Examples of these types of features can include under-cuts, thin-wall sections, or other features.

In other cases, one or more portions of the attachment feature 316 can be machined, bonded, or otherwise attached to the frame 306. For example, a threaded insert can be molded or otherwise attached to the frame 306, and the threaded insert can be used to couple the electronic component 312 to the housing 302. In some cases, the threaded insert can be formed from a metal or other suitable material.

FIG. 5A shows a top perspective view of an example multipart housing structure 502 for an electronic device 500, which can be an example of the electronic devices described herein. The multipart housing structure 502 can be an example of the multipart housing structures defined herein and include a shell 504 and a frame 506. As described herein, the shell 504 can be a formed sheet metal component and the frame 506 can be molded to the sheet metal component. The electronic device 500 can also include a back assembly 508 which can be coupled to the frame 506.

In some cases, the frame 506 can define a portion of a back of the electronic device 500 and the back assembly 508 can be coupled to the frame 506 to define a portion of a sealed internal cavity of the electronic device 500. For example, the back assembly can include optical, electronic, and/or other sensors that are configured to measure physiological parameters of a user such as heart rate, temperatures, electrical cardiac activity, blood parameters, and so on. In some cases, the back assembly can include sensors such as a photoplethysmography (PPG) sensor, electrocardiogram (ECG) sensor components, and/or the like.

As shown in FIG. 5B the frame 506 can define an opening 510 in the back portion of the electronic device 500 and the back assembly 508 can fit into the opening 510. In some cases, the opening 510 can include a ledge, or other suitable features for supporting, aligning, or otherwise coupling with the back assembly 508.

In some cases, the back assembly can include an optical component such as an optical window that is molded to the frame 506. For example, the frame 506 can be molded from a first material (e.g., an opaque or non-transparent material) and a second optically transparent material that is configured to pass transmitted light to and from sensors positioned within the housing 502.

An electronic device such as the electronic devices described herein can include multiple external components such as a cover, button interface, crown, and back assembly that couple to the inner frame (e.g., frame 506) to define a sealed internal cavity for the electronic device. Coupling each external component to the inner frame can reduce manufacturing complexity, cost, and/or increase the robustness of the electronic device by reducing the number of different sealing interfaces.

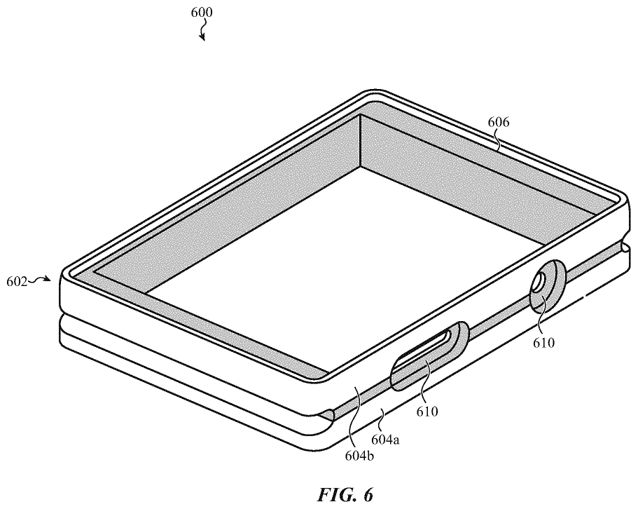

FIG. 6 shows a perspective view of an example multipart housing structure 602 for an electronic device 600. The electronic device 600 can be an example of the electronic devices described herein and the multipart housing structure 602 can be an example of the multipart housing structures described herein. The multipart housing structure 602 can include a shell 604 which can be a formed sheet metal component, and a frame 606 which can be molded to the shell 604 as described herein.

In some cases, the shell 604 can be formed from multiple sheet metal parts that are separated by the frame 606. For example, the shell 604 can include a first shell portion 604a that forms a bottom portion of the multipart housing structure 602 and a second shell portion 604b that forms an upper portion of the multipart housing structure 602. In some cases, the frame 606 can define a portion of the outer surface that separates the first shell portion 604a and the second shell portion 604b. In some cases, the frame 606 can include an electrically insulating material that electrically isolates that first shell portion 604a from the second shell portion 604b. In some cases, different shell portions can be coupled to the antenna and operate as different antenna signal feed and ground injection points. For example, an antenna can include multiple feed and ground points.

In some cases, the frame 606 can define input regions 610 that define openings for an input component such as a button, crown, or other input/output components as described herein. In this regard, the frame 606 can electrically isolate input components such as a crown from the sheet metal components.

In some embodiments, one or more portions of the multipart housing structure 602 can operate as antenna components to transmit and/or receive wireless signals. For example, the first shell portion 604a can function as a ground for the antenna system and the second shell portion 604b can be coupled to wireless communication circuitry and used to transmit and/or receive components for an antenna system. In this regard, the frame 606 can separate the shell portions to allow different portions of the multipart housing structure 602 to perform different antenna functions. In some cases, the shell 604 includes a slot antenna. For example, the shell 604 can be a continuous sheet metal part that defines one or more slots that extend along one or more sides of the antenna. The frame 606 can be molded to the shell to fill the slots and define an outer portion of the surface. The slot may be configured to radiate electromagnetic radiation at a particular frequency and/or in a particular frequency range. The length of the slot may be configured so that the slot radiates at one or more desired frequencies. For example, the length of the slot may be one half of a desired wavelength of electromagnetic radiation. The slot can extend across one or more of the sides of the housing. The slot may also be configured to define a minimum gap height and/or a minimum overlap between the edges defining the slot.

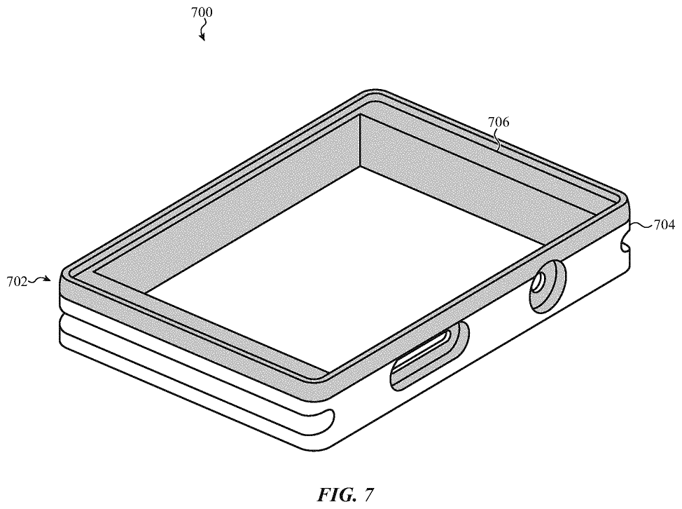

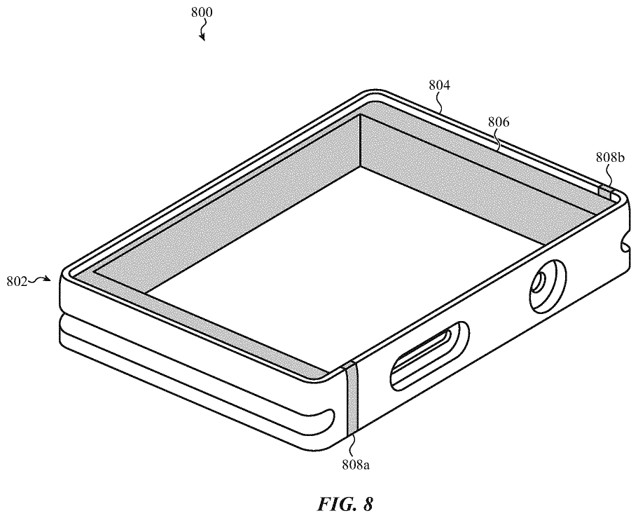

FIG. 7 shows a perspective view of an example multipart housing structure 702 for an electronic device 700, which can be an example of the electronic devices described herein. The multipart housing structure 702 shows an example of a frame 706 that forms an upper portion of the multipart housing structure 702 and a shell 704 that forms a lower portion of the housing, such as a portion that contacts a user. In this example, the frame 706 can be formed from a molded insulating material and the shell 704 can be a formed sheet metal component as described herein. The multipart housing structure 702 may help reduce interference between an antenna that is integrated into a display stack (e.g., antenna 118 in display assembly 105) by providing greater separation between the antenna 118 and the shell (e.g., shell 704).

FIG. 8 shows a perspective view of an example multipart housing structure 802 for an electronic device 800, which can be an example of the electronic devices described herein. The multipart housing structure 802 shows another example of a frame 806 separating different portions of a shell 804 that is formed from a conductive material such as sheet metal, as described herein.

The multipart housing structure 802 can include a first intermediate component 808a and a second intermediate component 808b that isolate a portion of the shell 804 such as the side and corner portion of the shell 804. In this regard, the different separated portions of the shell 804 can perform different functions. For example, the isolated portion can form a first component of an antenna structure and the other portion of the shell 804 can form a second part of an antenna structure. Additionally or alternatively, the isolated portion of the shell 804 can function as an isolated electrode for physiological monitoring such as cardiac electrical sensing, and so on. In some cases, the intermediate components 808 can be part of the frame 806 and formed from the same material as the frame 806, such as during a molding process. In other cases, the intermediate components 808 can be formed from other materials. FIGS. 6, 7, and 8 provide examples of housing structures in which conductive sheet metal sections are separated by an insulating material(s) such as the molded frame and/or intermediate components. These concepts are provided to illustrate the concepts, which can be applied to create combinations of these structures or other structures in which one segment of the outer shell is isolated from another portion of the outer shell.

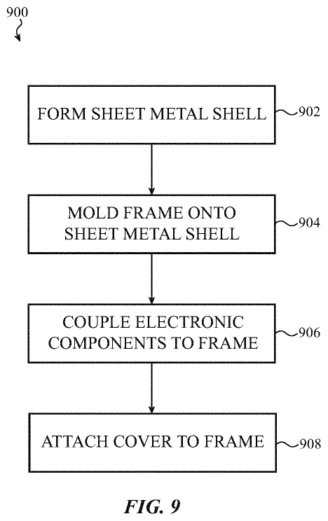

FIG. 9 is an example process 900 for creating an electronic device with a multipart housing structure, such as the devices described herein.

At operation 902 the process 900 can include forming the outer shell. The outer shell can be a sheet metal component that is formed from a thin sheet of metal material and using processes such as stamping, bending, laser cutting, curling, hydroforming, punching, seaming, or other suitable sheet metal forming processing. In some cases, the sheet metal shell can include multiple sheet metal pieces that are formed and joined together through processes such as brazing, welding, soldering, and so on. In other cases, multiple sheet metal parts can be held together by the inner frame, such as by molding the inner frame to the outer shell to fix the sheet metal pieces in a desired configuration.

The outer shell can be formed from sheet metal having a uniform thickness. In some cases, the sheet metal shell can have a thickness that is less than one millimeter. The thickness of the sheet metal can include a thickness that is between 0.2 millimeters and 0.8 millimeters. In some cases, the thickness of the sheet metal can be less than 0.5 millimeters. In other cases, the shell can be formed from sheet metal having thickness variations or other features such as openings. The outer shell can be formed from steel such as a stainless-steel material, aluminum materials, titanium, or any other suitable alloys.

Operation 902 can also include finishing or other processing techniques such as polishing, sanding, coating, surface priming to facilitate bonding of the inner molded frame, or any other suitable process. The outer shell can be formed from sheet metal having a uniform thickness of steel, aluminum, titanium, or other suitable metals or alloys

At operation 904, the process 900 can include molding the frame onto the sheet metal shell. The molding operations can include slot molding, over molding or other operations that form the frame material directly onto the sheet metal shell. In some cases, adhesion promoters, adhesives, or other features may be used to promote coupling of the molded inner frame to the sheet metal shell. The molded inner frame can include molding polymer materials as described herein, which can include high temperature and/or high-pressure molding processes.

In some cases, operation 904 can include molding multiple materials to create the multi-part housing. For example, a first material can be molded to the sheet metal shell to form the inner frame and a second material can be molded to the inner frame to create components such as button interfaces or other structures that are coupled to the inner frame and/or sheet metal shell. The second material can be different from the first material. For example, the first material may be a harder material to create a more rigid frame, and the second material may be a softer material to facilitate deformation of an input/output interface, for example, in response to a user touch.

At operation 906, the process 900 can include attaching electronic components to the frame. This can include attaching batteries, integrated circuits, processing components, haptic engines, sensors, input/output devices such as speakers and microphones, or any other suitable component. The inner frame can be molded with features that are used to attach, align, or otherwise help facilitate mounting of the electronic components to the housing.

At operation 908, the process 900 can include attaching a cover to the frame. As described herein the cover can be formed from a transparent material and coupled to the inner frame. In some cases, other external structures such as a back assembly described herein can be coupled to the frame. The cover and/or other components can be coupled to the frame using adhesives such as pressure sensitive adhesives, seals, or other features. In some cases, a seal can be attached or pre-molded to the frame and activated after assembly to form a bond with a component such as a cover. For example, a thermally or photo-activated adhesive can be deposited on the frame in a location that the cover attaches. After positioning the cover on the inner frame, the thermal or photo adhesive can be activated to seal the cover to the frame. In some cases, the seal between the frame and the cover and/or other components can be configured to meet water resistance and/or debris standards. For example, the seals can be configured to resist water ingress to up to 90 meters depth. In other cases, the seals can be configured to withstand water ingress over 90 meters depth. In yet other cases, the housing and seals of components such as the cover can be configured to protect from water ingress, dust, debris, or other materials according to standards such as the ingress protection (IP) standard. For example, the housing and seals can be configured to meet various IPX standards.

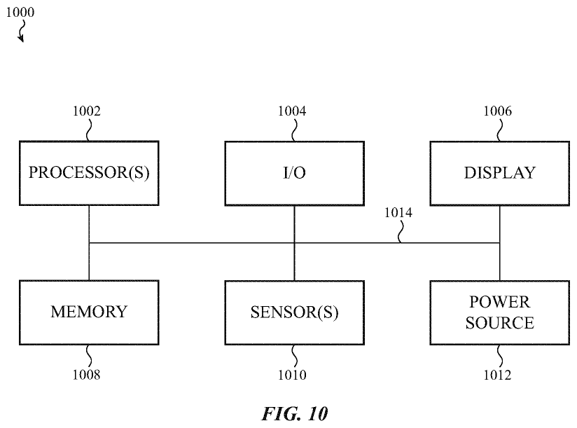

FIG. 10 is an example block diagram of an electronic device having a multipart housing structure, which can take the form of any of the devices as described with references to FIGS. 1-9. The electronic device 1000 can include a processor 1002, an input/output (I/O) mechanism 1004 (e.g., wired or wireless communications interfaces), a display 1006, memory 1008, sensors 1010 (e.g., physiological sensors), and a power source 1012 (e.g., a rechargeable battery). The processor 1002 can control some or all of the operations of the electronic device 1000. The processor 1002 can communicate, either directly or indirectly, with some or all of the components of the electronic device 1000. For example, a system bus or other communication mechanism 1014 can provide communication between the processor 1002, the I/O mechanism 1004, the memory 1008, the sensors 1010, and the power source 1012.

The processor 1002 can be implemented as any electronic device capable of processing, receiving, or transmitting data or instructions. For example, the processor 1002 can be a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitable computing element or elements.

It should be noted that the components of the electronic device 1000 can be controlled by multiple processors. For example, select components of the electronic device 1000 (e.g., a sensor 1010) may be controlled by a first processor and other components of the electronic device 1000 and other component of the electronic device 1000 (e.g., the I/O 1004) may be controlled by a second processor, where the first and second processors may or may not be in communication with each other.

The I/O device 1004 can transmit and/or receive data from a user or another electronic device. An I/O device can transmit electronic signals via a communications network, such as a wireless and/or wired network connection. Examples of wireless and wired network connections include, but are not limited to, cellular, Wi-Fi, Bluetooth, IR, and Ethernet connections. In some cases, the I/O device 1004 can communicate with an external electronic device, such as a smartphone, smartwatch, or other portable electronic device, as described here.

The electronic device may optionally include a display 1006 such as a liquid-crystal display (LCD), an organic light emitting diode (OLED) display, a light emitting diode (LED) display, or the like. If the display 1006 is an LCD, the display 1006 may also include a backlight component that can be controlled to provide variable levels of display brightness. If the display 1006 is an OLED or LED type display, the brightness of the display 1006 may be controlled by modifying the electrical signals that are provided to display elements. The display 1006 may correspond to any of the displays shown or described herein.

The memory 1008 can store electronic data that can be used by the electronic device 1000. For example, the memory 1008 can store electrical data or content such as, for example, audio and video files, documents and applications, device settings and user preferences, timing signals, control signals, and data structures or databases. The memory 1008 can be configured as any type of memory. By way of example only, the memory 1008 can be implemented as random access memory, read-only memory, Flash memory, removable memory, other types of storage elements, or combinations of such devices.

The electronic device 1000 may also include one or more sensors 1010 positioned almost anywhere on the electronic device 1000. The sensor(s) 1010 can be configured to sense one or more types of parameters, such as but not limited to, pressure, light, touch, heat, movement, relative motion, biometric data (e.g., biological parameters), and so on. For example, the sensor(s) 1010 may include a heat sensor, a position sensor, a light or optical sensor, an accelerometer, a pressure transducer, a gyroscope, a magnetometer, a health monitoring sensor, and so on. Additionally, the one or more sensors 1010 can utilize any suitable sensing technology, including, but not limited to, capacitive, ultrasonic, resistive, optical, ultrasound, piezoelectric, and thermal sensing technology.

The power source 1012 can be implemented with any device capable of providing energy to the electronic device 1000. For example, the power source 1012 may be one or more batteries or rechargeable batteries. Additionally or alternatively, the power source 1012 can be a power connector or power cord that connects the electronic device 1000 to another power source, such as a wall outlet.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A portable wearable device comprising:
a housing comprising:
a shell formed from a sheet metal material and defining an exterior surface of the portable wearable device;
a frame formed from a polymer material molded to an inner surface of the shell, the frame defining an opening and a ledge extending around the opening; and
a cover coupled to the ledge of the frame, the frame and the cover defining at least a portion of a sealed cavity; and
a display assembly coupled to an inner surface of the cover and positioned within the sealed cavity.

2. The portable wearable device of claim 1, wherein:
the display assembly further comprises an antenna configured to conduct wireless communications;
the shell defines an upper shell portion and a lower shell portion; and
the upper shell portion is electrically coupled to the antenna.

3. The portable wearable device of claim 2, wherein:
a portion of the frame is positioned between the upper shell portion and the lower shell portion; and
the portion of the frame defines a portion of an exterior surface of the housing.

4. The portable wearable device of claim 1, wherein:
the shell defines a band attachment feature and a side opening; and
the portable wearable device further comprises:
a band coupled to the housing by the band attachment feature; and
an input device positioned at least partially within the side opening.

5. The portable wearable device of claim 1, wherein:
the portable wearable device further comprises a circuit assembly positioned within the sealed cavity;
the frame comprises one or more threaded attachment features; and
the circuit assembly is coupled to the housing by the one or more threaded attachment features.

6. The portable wearable device of claim 1, wherein:
the shell defines a back wall and a set of side walls that extend from the back wall; and
the back wall and the set of side walls have a substantially uniform thickness.

7. The portable wearable device of claim 1, wherein the cover and the frame are coupled to form a water-resistant seal.

8. An electronic watch comprising:
a housing comprising;
a shell formed from a sheet metal material;
a first molded component formed from a first polymer material molded to an inner surface of the shell; and
a second molded component formed from a second polymer material molded to the first molded component, the second molded component configured to deflect in response to a press input;
a cover coupled to the first molded component, the first molded component and the cover at least partially defining a sealed cavity;
a touch-sensitive display coupled to the cover and configured to detect a touch input on the cover; and
an input device positioned inward of the second molded component and configured to detect the press input.

9. The electronic watch of claim 8, wherein:
the first polymer material of the first molded component has a first hardness; and
the second polymer material of the second molded component has a second hardness less than the first hardness.

10. The electronic watch of claim 8, wherein the first molded component and the second molded component define a water-resistant interface.

11. The electronic watch of claim 8, wherein:
the shell defines an opening along a side of the housing; and
the second molded component is positioned at least partially within the opening.

12. The electronic watch of claim 8, wherein:
the shell defines a first band slot formed along a first side of the housing;
the shell defines a second band slot formed along a second side of the housing; and
the first and second band slots are configured to couple a band to the housing.

13. The electronic watch of claim 11, wherein:
the shell defines a back wall having a first thickness; and
the shell defines a side wall extending from the back wall and having a second thickness.

14. The electronic watch of claim 13, wherein the first thickness and the second thickness are less than 0.5 mm.

15. A wearable electronic device comprising:
a housing comprising;
a first sheet metal component defining a first portion of an exterior surface of the wearable electronic device;
a second sheet metal component defining a second portion of the exterior surface;
a frame component molded to the first sheet metal component and the second sheet metal component, and defining a third portion of the exterior surface; and
a cover coupled to the frame component;
a display positioned inward of the cover; and
an antenna positioned inward of the cover and electrically coupled to the first sheet metal component.

16. The wearable electronic device of claim 15, wherein:
the first sheet metal component defines a front portion of the housing surrounding the cover; and
the second sheet metal component defines a rear portion of the housing configured to contact a wrist of a user when the wearable electronic device is worn.

17. The wearable electronic device of claim 15, wherein:
the antenna and the first sheet metal component are operably coupled to wireless communication circuitry and configured to radiate radio-frequency signals; and
the second sheet metal component is operably coupled to an electrical ground of the wearable electronic device.

18. The wearable electronic device of claim 15, wherein the frame component electrically isolates the first sheet metal component from the second sheet metal component.

19. The wearable electronic device of claim 15, further comprising an input component coupled to the frame component.

20. The wearable electronic device of claim 19, wherein:
the input component comprises a crown; and
the frame component electrically isolates the crown from the first and second sheet metal components.
